(19) United States
(12) Patent Application Publication
(10) Pub. No.: US 2019/0107505 A1
(43) Pub. Date: Apr. 11, 2019

(54) SENSOR CONTROL DEVICE AND SENSOR UNIT

(71) Applicant: NGK SPARK PLUG CO., LTD., Nagoya-shi (JP)

(72) Inventors: Takanori NUNOME, Komaki-shi (JP); Tomomi IMAIDA, Nagoya-shi (JP); Satoshi TERAMOTO, Nisshin-shi (JP)

(73) Assignee: NGK SPARK PLUG CO., LTD., Nagoya-shi (JP)

(21) Appl. No.: 16/132,558

(22) Filed: Sep. 17, 2018

(30) Foreign Application Priority Data
Oct. 6, 2017 (JP) 2017-196042

(51) Int. Cl. G01N 27/407; G01N 27/406; G01N 27/419

(52) U.S. Cl. CPC G01N 27/407; G01N 27/419; G01N 27/4065

(57) ABSTRACT

Disclosed is a sensor control device for controlling a gas sensor of the type having a sensor element, in which a pair of electrodes are arranged on a solid electrolyte body to cause a concentration detection current between the electrodes, and a heater. The sensor control device includes a temperature detection portion for detecting a temperature value of the solid electrolyte body and a control portion for performing feedback control on a heat generation amount of the heater based on a predetermined feedback condition. The feedback condition is set such that, when an evaluation gas simulating an engine exhaust gas discharged by combustion of a stoichiometric air-fuel ratio mixture is supplied as the gas under measurement at 25° C. while switching a gas flow rate of the evaluation gas between 10 m/s and 60 m/s every 10 seconds, a variation width of the concentration detection current is 1.6 μA or smaller.

### FIELD OF THE INVENTION

The present invention relates to a sensor control device for controlling a gas sensor of the type having a sensor element and a heater. The present invention also relates to a sensor unit equipped with a gas sensor and a sensor control device.

### BACKGROUND OF THE INVENTION

There is known a sensor control device for controlling a gas sensor of the type having a sensor element and a heater as disclosed in Japanese Laid-Open Patent Publication No. H11-304758.

### SUMMARY OF THE INVENTION

The gas concentration detection accuracy of the gas sensor may be deteriorated in an environment where the temperature of the sensor element suddenly changes.

It is an object of the present invention to provide a technique for improving the gas concentration detection accuracy of a gas sensor.

In accordance with a first aspect of the present invention, there is provided a sensor control device for controlling a gas sensor, the gas sensor comprising a sensor element and a heater that heats the sensor element and being adapted for detecting the concentration of a specific gas component contained in a gas under measurement, the sensor element having at least one cell that includes a solid electrolyte body and a pair of electrodes arranged on the solid electrolyte body so as to cause a flow of concentration detection current between the pair of electrodes in accordance with the concentration of the specific gas component, the sensor control device comprising:

a temperature detection portion configured to detect a temperature value of the solid electrolyte body; and

a control portion configured to perform feedback control on a heat generation amount of the heater based on a predetermined feedback condition so that a deviation between the detected temperature value and a predetermined target value becomes zero,

wherein the feedback condition is set such that, when an evaluation gas simulating a combustion exhaust gas discharged from an internal combustion engine by combustion of a stoichiometric air-fuel ratio mixture in the internal combustion engine is supplied as the gas under measurement to the gas sensor while maintaining a temperature of the evaluation gas at 25° C. and switching a gas flow rate of the evaluation gas between 10 m/s and 60 m/s every 10 seconds, a variation width of the concentration detection current is 1.6 μA or smaller.

Herein, the temperature value of the solid electrolyte body refers to a temperature of the solid electrolyte body or any other parameter value correlated with the temperature of the solid electrolyte body (such as impedance or admittance of the solid electrolyte body).

The above-configured sensor control device limits the variation width of the concentration detection current to 1.6 μA or smaller even in an environment where the temperature of the sensor element suddenly changes. The variation width of the concentration detection current can be limited smaller by the above-configured sensor control device than by conventional sensor control devices. Therefore, the above-configured sensor control device enables the gas sensor to carry out gas concentration detection with improved accuracy, as compared to the conventional sensor control devices, even in a transient state where the temperature of the sensor element changes.

In accordance with a second aspect of the present invention, there is provided a sensor control device as described above,

wherein the feedback condition includes a feedback term.

In accordance with a third aspect of the present invention, there is provided a sensor control device as described above,

wherein the feedback condition includes at least a proportional term and an integral term as feedback terms.

In accordance with a fourth aspect of the present invention, there is provided a sensor unit, comprising:

a gas sensor comprising a sensor element that has at least one cell, which includes a solid electrolyte body and a pair of electrodes arranged on the solid electrolyte body, and a heater that heats the sensor element; and

a sensor control device as described above.

The thus-obtained sensor unit attains the same effects as those of the above-configured sensor control device.

The other objects and features of the present invention will also become understood from the following description.

### BRIEF DESCRIPTION OF DRAWINGS

FIG. 1 is a schematic diagram of a system to which a sensor unit with a gas sensor and a sensor control device according to one embodiment of the present invention is applied.

FIG. 2 is a schematic diagram of the gas sensor and the sensor control device according to the one embodiment of the present invention.

FIG. 3 is a graph showing time changes of parameter values ΔRpvs and ΔIp of the gas sensor.

FIG. 4 is a graph showing a relationship between parameter values dRpvs/dt and ΔIp of the gas sensor.

FIGS. 5A to 5C are graphs showing test results of Comparative Example.

FIGS. 6A to 6C are graphs showing test results of Example according to the present invention.

### DESCRIPTION OF EMBODIMENTS

Hereinafter, embodiments of the present invention will be described below with reference to the drawings.

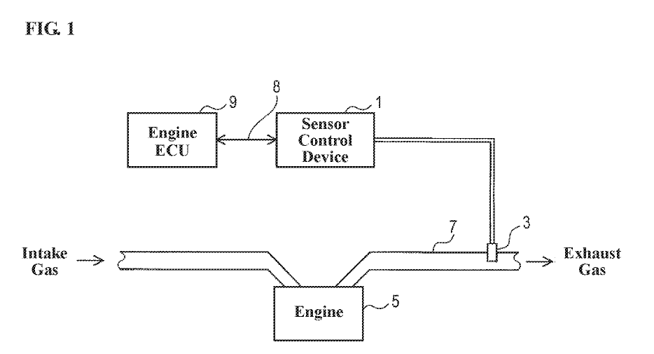

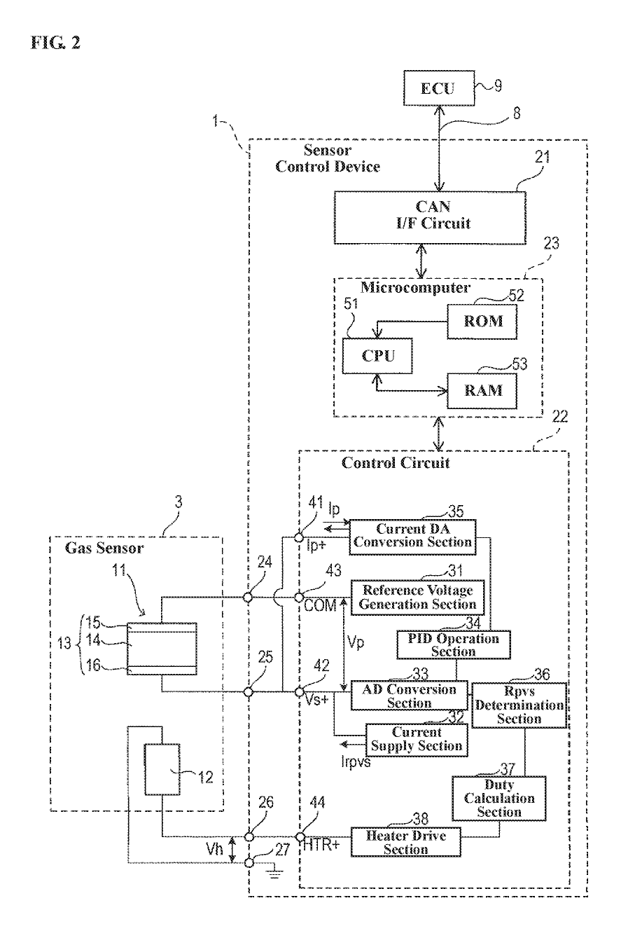

FIGS. 1 and 2 show a sensor unit according to one embodiment of the present invention. In the present embodiment, the sensor unit is designed for use on a vehicle and is equipped with a sensor control device 1 and a gas sensor 3 as shown in FIGS. 1 and 2.

The sensor control device 1 is mounted to the vehicle and is configured to control operations of the gas sensor 3. The sensor control device 1 is connected via a communication line 8 to an electronic control unit (ECU) 9, which is configured to control operations of an internal combustion engine 5, so that the sensor control device 1 can transmit data to and receive data from the electronic control unit 9 through the communication line 8. (The electronic control unit 9 is hereinafter referred to as “engine ECU 9”).

The gas sensor 3 is mounted to an exhaust pipe 7 of the internal combustion engine 5 and adapted to detect the concentration of oxygen contained in exhaust gas from the internal combustion engine. In the present embodiment, the gas sensor 3 is provided as a so-called “linear lambda sensor” capable of oxygen concentration detection over a wide range of concentrations.

As shown in FIG. 2, the gas sensor 3 includes a sensor element 11 and a heater 12.

The sensor element 11 has a pump cell 13. The pump cell 13 includes an oxygen ion conductive solid electrolyte body 14 formed of partially stabilized zirconia in a plate shape and a pair of pump electrodes 15 and 16 mainly formed of platinum and arranged on front and back surfaces of the oxygen ion conductive solid electrolyte body 14. Although not specifically shown in the drawings, there are a measurement gas chamber and a reference oxygen chamber defined within the sensor element 11. The pump electrode 15 is exposed to the measurement gas chamber, whereas the pump electrode 16 is exposed to the reference oxygen chamber. The exhaust gas is introduced as a gas under measurement into the measurement gas chamber through a porous diffusion layer (not shown) from the outside of the sensor element 11. On the other hand, the air is introduced as a reference gas into the reference oxygen chamber from the outside of the sensor element 11.

The sensor element 11 is in the form of an oxygen sensor element that detects oxygen concentration by a so-called “limiting current method”. The output characteristics of the sensor element 11, which represent a relationship between a voltage applied between the pair of pump electrodes 15 and 16 (hereinafter referred to as “sensor element voltage Vp) and a current flowing between the pair of pump electrodes 15 and 16 (hereinafter referred to as “pumping current Ip”; corresponding to the claimed concentration detection current), include a proportional region and a flat region. In the proportional region, the pumping current Ip changes in proportion to increase of the sensor element voltage Vp. In the flat region, the pumping current Ip is maintained at a constant value with substantially no change irrespective of change of the sensor element voltage Vp. This flat region is a region of limiting current (hereinafter referred to as “limiting current region”) at which the pumping current Ip is maintained constant with respect to the sensor element voltage Vp.

It is known that, in the limiting current region, the pumping current Ip shows a value according to the oxygen concentration. The value of the pumping current Ip in the limiting current region (called “limiting current value”) increases with increase in the oxygen concentration. Namely, the higher the concentration of oxygen contained in the exhaust gas (that is, the leaner the air-fuel ratio), the larger the limiting current value; and the lower the concentration of oxygen contained in the exhaust gas (that is, the richer the air-fuel ratio), the smaller the limiting current value. The concentration of oxygen contained in the exhaust gas can be thus detected over a wide range by measuring the pumping current Ip under the application of the sensor element voltage Vp corresponding to the limiting current region.

The heater 12 has a heater body formed of e.g. an alumina-based material and a heating resistor formed of e.g. a platinum-based material and embedded in the heater body. The heating resistor is electrically connected at both ends thereof to the sensor control device 1 so that, with the supply of power from the sensor control device 1, the heater 12 generates heat to heat the sensor element 11 to an activation temperature.

The gas sensor 3 is put into a gas detectable state when the sensor element 11 is activated by heat from the heater 12.

As shown in FIG. 2, the sensor control device 1 includes a CAN interface circuit 21 (hereinafter referred to as “CAN I/F circuit 21”), a control circuit 22, a microcomputer 23 and connection terminals 24, 25, 26 and 27. Herein, “CAN” is a trademark abbreviation of Controller Area Network.

The CAN I/F circuit 21 performs data communication with the engine ECU 9 through the communication line 8 according to CAN communication protocol.

The control circuit 22 is provided as an application specific integrated circuit (ASIC). The control circuit 22 has a reference voltage generation section 31, a current supply section 32, an analog-digital conversion section 33 (hereinafter referred to as “AD conversion section 33”), a PID operation section 34, a current digital-analog conversion section 35 (hereinafter referred to as “current DA conversion section 35”), a Rpvs determination section 36, a duty calculation section 37 and a heater drive section 38. The control circuit 22 also has a pumping current terminal 41 (hereinafter referred to as “Ip+ terminal 41”), a detection voltage terminal 42 (hereinafter referred to as “Vs+ terminal 42”), a common terminal 43 (hereinafter referred to as “COM terminal 43”) and a heater terminal 44 (hereinafter referred to as “HTR+ terminal 44”). The Ip+ terminal 41 and the Vs+ terminal 42 are connected to the connection terminal 25 of the sensor control device 1. The COM terminal 43 is connected to the connection terminal 24 of the sensor control device 1. The pump electrodes 15 and 16 are respectively connected to the connection terminals 24 and 25 of the sensor control device 1. The HTR+ terminal 44 is connected to the connection terminal 26 of the sensor control device 1. The both ends of the heater 12 (heating resistor) are respectively connected to the connection terminals 26 and 27 of the sensor control device 1. Further, the connection terminal 27 is grounded.

The reference voltage generation section 31 generates and applies a reference voltage to the COM terminal 43. In the present embodiment, the reference voltage is set to 2.7 V.

The current supply section 32 supplies a pulse current Irpvs to the sensor element 11 through the Vs+ terminal 42 for detection of an internal resistance value Rpvs of the pump cell 13. The current supply section 32 does not supply the pulse current Irpvs is not supplied continuously at all times, but supplies the pulse current Irpvs periodically for a predetermined time period on the basis of a command from the microcomputer 23.

The AD conversion section 33 converts an analog signal (voltage value) inputted from the Vs+ terminal 42 into digital data and outputs the digital data to the PID operation section 34 and to the Rpvs determination section 36.

The PID operation section 34 performs processing operation for PID control of the pumping current Ip based on the digital data inputted from the AD conversion section 33 such that a voltage difference between the Vs+ terminal 42 and the COM terminal 43 becomes a predetermined control reference voltage. In the present embodiment, the control reference voltage is set to 400 mV. The PID operation section 34 determines the value of the pumping current Ip by the PID operation and outputs digital data representing the determined current value to the current DA conversion section 35.

The current DA conversion section 35 supplies current to the sensor element 11 through the Ip+ terminal 41 according to the digital data (current value) inputted from the PID operation section 34.

The Rpvs determination section 36 performs processing operation to determine the internal resistance value Rpvs of the pump cell 13 based on the digital data inputted from the AD conversion section 33 during the supply of the pulse current Irpvs from the current supply section 32 to the sensor element 11, and then, outputs digital data representing the determined internal resistance value Rpvs to the duty calculation section 37.

The duty calculation section 37 calculates, based on the digital data inputted from the Rpvs determination section 36, a heat generation amount of the heater 12 required to maintain the temperature of the sensor element 11 at a predetermined sensor target temperature. The duty calculation section 37 further calculates a duty ratio of power supplied to the heater 12 based on the calculated heat generation amount. The duty calculation section 37 generates a pulse-width-modulation (PWM) control signal according to the calculated duty ratio and outputs the PWM control signal to the heater drive section 38.

In the present embodiment, the duty calculation section 37 performs feedback control for calculation of the heat generation amount. More specifically, the duty calculation section 37 calculates a deviation between the internal resistance value Rpvs inputted from the Rpvs determination section 36 and a target internal resistance value corresponding to the sensor target temperature, and then, calculates a proportional term and an integral term as feedback terms based on the deviation. Herein, the proportional term is calculated by multiplying the deviation by a predetermined proportional gain; and the integral term is calculated by multiplying an integrated value of the deviation by a predetermined integral gain. The duty calculation section 37 calculates a result of addition of the proportional term and the integral term as the heat generation amount. In the present embodiment, the proportional gain is set to 1670; and the integral gain is set to 750.

The heater drive section 38 drives the heater 12 by PMW control of the voltage Vh applied between the both ends of the heater 12 in accordance with the PWM control signal inputted from the duty calculation section 37.

The microcomputer 23 has a CPU 51, a ROM 52 and a RAM 53. Various functions of the microcomputer 23 are accomplished by the CPU 51 executing programs stored in a non-transitory tangible storage media. In the present embodiment, the ROM 52 corresponds to the non-transitory tangible storage media storing therein the programs. By the execution of a program, the microcomputer 23 performs a function corresponding to the executed program. The sensor control device 1 may have a single microcomputer or a plurality of microcomputers. A part or all of the functions executed by the microcomputer 23 may be configured as hardware with a single IC or a plurality of ICs.

In the present embodiment, the CPU 51 determines the oxygen concentration according to the flow direction and value of the pumping current Ip through the execution of a program stored in the ROM 52.

Herein, the following terms are defined as follows: ΔRpvs is an internal resistance difference determined by subtracting the target internal resistance value from the determined internal resistance value Rpvs; ΔIp is a pumping current difference as determined by subtracting a value of the pumping current Ip corresponding to the target internal resistance value from a value of the pumping current Ip corresponding to the determined internal resistance value Rpvs; and dRpvs/dt is an integrated value representing an amount of change of the internal resistance value Rpvs per unit time.

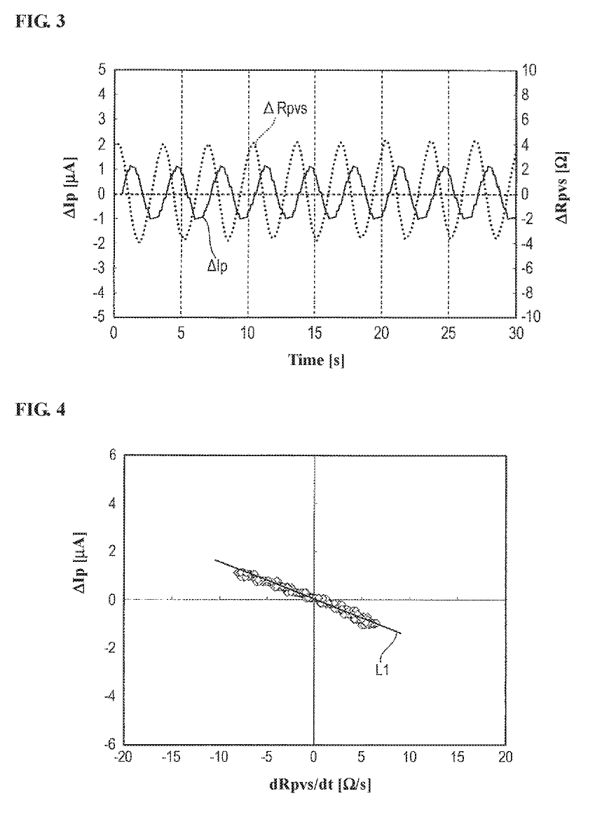

FIG. 3 shows time changes of the internal resistance difference ΔRpvs and the pumping current difference ΔIp in the case where the internal resistance value Rpvs periodically increases and decreases with reference to the target internal resistance value. As shown in FIG. 3, the pumping current difference ΔIp periodically increases and decreases with time in accordance with periodical increase and decrease of the internal resistance difference ΔRpvs.

FIG. 4 shows a relationship of the integral value dRpvs/dt and the pumping current difference ΔIp. As shown by a straight line L1 in FIG. 4, the relationship of the integral value dRpvs/dt and the pumping current difference ΔIp can be expressed by a linear (first-order) equation. More specifically, the relationship of the integral value dRpvs/dt and the pumping current difference ΔIp is expressed by the following equation (1):

ΔIp=A×dRpvs/dt+B (1)

where the coefficient A is a gradient of the linear equation represented by the straight line L1; and the coefficient B is an intercept of the linear equation represented by the straight line L1. In FIG. 4, the value of the coefficient A is set to about −0.15; and the value of the coefficient B is set to 0.

For the purpose of evaluation of changes of the pumping current Ip in response to sudden changes of the temperature of the gas sensor 3, the following evaluation test was conducted on Example using the sensor control device 1 of the present embodiment and Comparative Example using a conventional sensor control device. The sensor control device of Comparative Example was the same in configuration as the sensor control device 1 of the present embodiment, except that the proportional gain and integral gain (as feedback gains) of the duty calculation section were respectively set to 245 and 235.

In the evaluation test, the gas sensor 3 was mounted to a gas flow pipe and driven normally. In this state, the pumping current Ip and the temperature of the sensor element 11 (hereinafter referred to as “element temperature”) of the gas sensor 3 were measured while supplying an evaluation gas as the gas under measurement to the gas sensor 3 through the gas flow pipe. The element temperature was determined based on the internal resistance value Rpvs outputted from the Rpvs determination section 36.

The evaluation gas used herein was a gas simulating a combustion exhaust gas discharged from the internal combustion engine 5 by combustion of an air-fuel mixture of stoichiometric air-fuel ratio (λ=1) in the internal combustion engine 5, i.e., a gas containing 13% by volume of carbon dioxide (CO₂) and the rest being nitrogen (N₂). During the evaluation test, the temperature of the evaluation gas was maintained constant at 25° C. Further, the gas flow pipe was equipped with a solenoid valve so that the gas flow rate of the evaluation gas was switched between 10 m/s and 60 m/s every 10 seconds by means of the solenoid valve to thereby cause sudden changes of the temperature of the gas sensor 3.

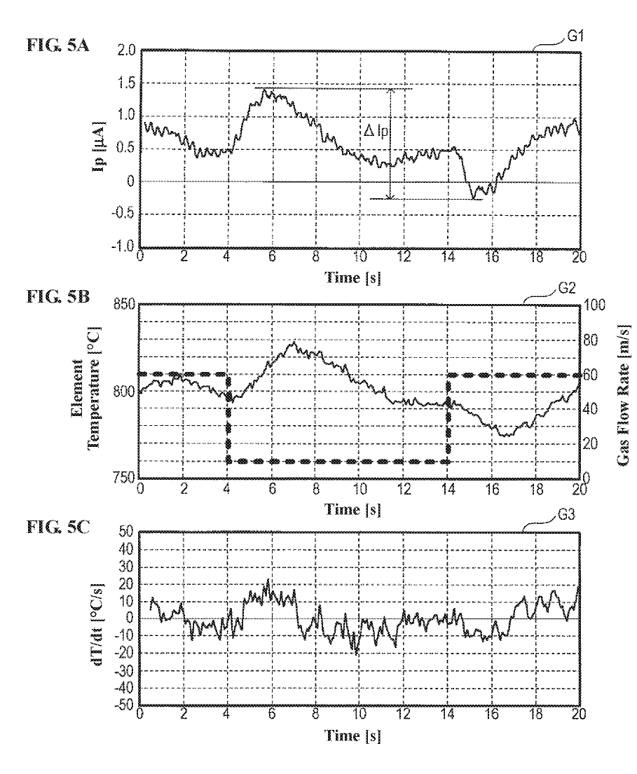

The results of the evaluation test of Comparative Example are plotted on Graphs G1 to G3 of FIGS. 5A to 5C, where Graph 1 shows changes of the pumping current Ip with time; Graph G2 shows changes of the element temperature and the gas flow rate with time; and Graph G3 shows changes of the integral value dT/dt of the element temperature with time.

As shown in Graph G2, the gas flow rate was maintained at 60 m/s during the time period from 0 second to 4 seconds, suddenly decreased from 60 m/s to 10 m/s at the time instant of 4 seconds, maintained at 10 m/s during the time period from 4 seconds to 14 seconds, suddenly increased from 10 m/s to 60 m/s at the time instant of 14 seconds, and then, maintained at 60 m/s during the time period from 14 seconds to 20 seconds.

When the gas flow rate was suddenly decreased from 60 m/s to 10 m/s at the time instant of 4 seconds, the element temperature increased from about 800° C. to about 830° C. as shown in Graph G2; and the pumping current Ip increased from about 0.5 μA to about 1.5 μA as shown in Graph G1. When the gas flow rate was suddenly increased from 10 m/s to 60 m/s at the time instant of 14 seconds, the element temperature decreased from about 790° C. to about 770° C. as shown in Graph G2; and the pumping current Ip decreased from about 0.5 μA to about −0.25 μA as shown in Graph G1.

In Comparative Example, the average value of the pumping current Ip during the time period from 0 second to 20 seconds was +0.60 μA; and the maximum and minimum values of the pumping current Ip during the time period from 0 second to 20 seconds were +1.47 μA and −0.24 μA, respectively. Namely, the variation range of the pumping current Ip (centered on the average pumping current value) in Comparative Example was from −0.84 μA to +0.87 μA. Thus, the variation width ΔIp of the pumping current Ip in Comparative Example was 1.71 μA.

As shown in Graph G3, the average value of the time integral value dT/dt during the time period from 0 second to 20 seconds was −0.063° C./s; and the maximum and minimum values of the time integral value dT/dt during the time period from 0 second to 20 seconds were +23.128° C. and −20.915° C./s, respectively. Thus, the variation range of the time integral value dT/dt (centered on the average time integral value) in Comparative Example was from −20.852° C./s to +23.191° C./s.

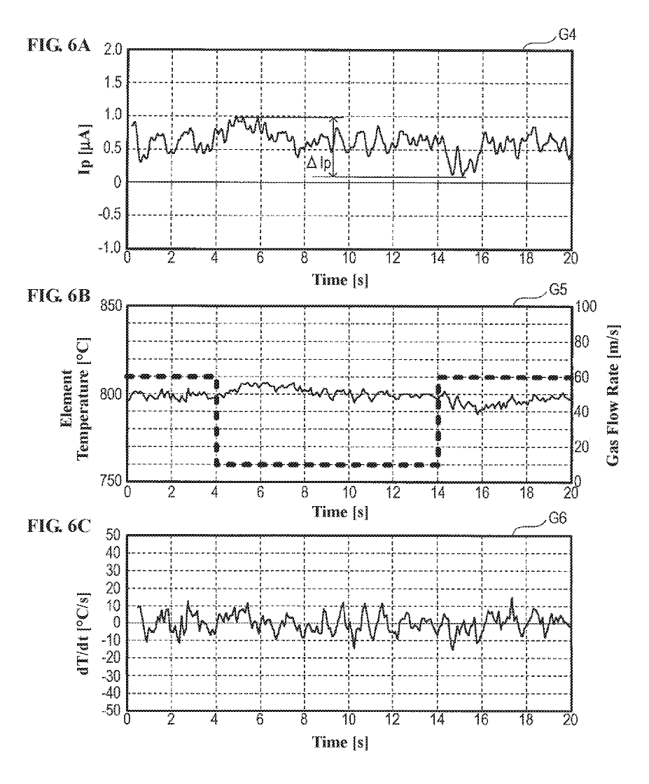

The results of the evaluation test of Example are plotted on Graphs G4 to G6 of FIGS. 6A to 6C, where Graph G4 shows changes of the pumping current Ip with time; Graph G5 shows changes of the element temperature and the gas flow rate with time; and Graph G6 shows changes of the integral value dT/dt of the element temperature with time.

As shown in Graph 5, the gas flow rate was maintained at 60 m/s during the time period from 0 second to 4 seconds, suddenly decreased from 60 m/s to 10 m/s at the time instant of 4 seconds, maintained at 10 m/s during the time period from 4 seconds to 14 seconds, suddenly increased from 10 m/s to 60 m/s at the time instant of 14 seconds, and then, maintained at 60 m/s during the time period from 14 seconds to 20 seconds.

When the gas flow rate was suddenly decreased from 60 m/s to 10 m/s at the time instant of 4 seconds, the element temperature increased from about 800° C. to about 810° C. as shown in Graph G5; and the pumping current Ip increased from about 0.7 μA to about 1.0 μA as shown in Graph G4. When the gas flow rate was suddenly increased from 10 m/s to 60 m/s at the time instant of 14 seconds, the element temperature decreased from about 800° C. to about 790° C. as shown in Graph G5; and the pumping current Ip decreased from about 0.7 μA to about 0.1 μA as shown in Graph G4.

In Example, the average value of the pumping current Ip during the time period from 0 second to 20 seconds was +0.62 μA; and the maximum and minimum values of the pumping current Ip during the time period from 0 second to 20 seconds were +0.98 μA and +0.12 μA, respectively. Namely, the variation range of the pumping current Ip (centered on the average pumping current value) in Example was from −0.50 μA to +0.36 μA. Thus, the variation width ΔIp of the pumping current Ip in Example was 0.86 μA.

As shown in Graph G6, the average value of the time integral value dT/dt during the time period from 0 second to 20 seconds was −0.003° C./s; and the maximum and minimum values of the time integral value dT/dt during the time period from 0 second to 20 seconds were +15.000° C. and −15.357° C./s, respectively. Thus, the variation range of the time integral value dT/dt (centered on the average time integral value) in Example was from −15.382° C./s to +15.075° C./s.

It is apparent from the above test results that the gas concentration detection result of the gas sensor 3 was more accurate with less variations in Example 1 than in Comparative Example even during transient changes in the element temperature.

As described above, the sensor control device 1 is configured to control the gas sensor 3. The gas sensor 3 is of the type having the sensor element 11 and the heater 12 that heats the sensor element 11 and is adapted for detecting the concentration of oxygen contained in the exhaust gas. The sensor element 11 includes the pump cell 13 in which a pair of electrodes 15 and 16 are arranged on the oxygen ion conductive solid electrolyte body 14. In the sensor control device 1, the Rpvs determination section 36 detects and determines the internal resistance value Rpvs of the pump cell 13, which is correlated with the temperature of the oxygen ion conductive solid electrolyte body 14; and the duty calculation section 37 performs feedback control on the heat generation amount of the heater 12 on the basis of the predetermined feedback condition (i.e. proportional and integral feedback terms) so that the deviation between the detected internal resistance value Rpvs and the target internal resistance value becomes zero. These feedback terms are set such that, when the evaluation gas (simulating the combustion exhaust gas discharged from the engine 5 by combustion of the stoichiometric air-fuel ratio mixture in the engine 5) is supplied as the gas under measurement to the gas sensor 3 while maintaining the temperature of the evaluation gas at 25° C. and switching the gas flow rate of the evaluation gas between 10 m/s and 60 m/s every 10 seconds, the variation width ΔIp of the pumping current Ip becomes 1.6 μA or smaller.

In this way, the sensor control device 1 limits the variation width ΔIp of the pumping current Ip to 1.6 μA or smaller even in an environment where the temperature of the sensor element 11 suddenly changes. As the variation width ΔIp of the pumping current Ip can be limited smaller by the sensor control device 1 than by the conventional sensor control device, the sensor control device 1 enables the gas sensor 3 to carry out gas concentration detection with improved accuracy as compared to the conventional sensor control device even in a transient state where the temperature of the sensor element 11 changes.

In the above-described embodiment, the oxygen ion conductive solid electrolyte body 14 corresponds to the claimed solid electrolyte body; the pump electrodes 15 and 16 correspond to the claimed pair of electrodes; the pump cell 13 corresponds to the claimed cell; the oxygen corresponds to the specific gas component; the pumping current Ip corresponds to the claimed concentration detection current; the internal resistance value Rpvs corresponds to the claimed temperature value of the solid electrolyte body; the target internal resistance value corresponds to the claimed target value; the Rpvs determination section 36 corresponds to the claimed temperature detection portion; and the duty calculation section 37 corresponds to the claimed control portion.

Although the present invention has been described with reference to the above embodiment, the above embodiment is intended to facilitate understanding of the present invention and is not intended to limit the present invention thereto. Various changes and modifications can be made to the above embodiment without departing from the scope of the present invention.

For example, the duty calculation section 35 may calculate a differential term in addition to the proportional term and the integral term as the feedback terms although the duty calculation section 37 calculates the proportional term and the integral term as the feedback terms in the above embodiment.

Although the oxygen sensor is used as the gas sensor in the above embodiment, the present invention is also applicable to any other gas sensor such as NOx sensor. When the oxygen sensor is used as the gas sensor, the oxygen sensor is not limited to the single-cell limiting-current type oxygen sensor as in the above embodiment. The present invention may be applied to another type of oxygen sensor such as two-cell type oxygen sensor in which a sensor element has two cells: an oxygen pumping cell with a pair of electrodes and an oxygen concentration detection cell with a pair of electrodes. The two-cell type oxygen sensor can detect oxygen concentration over a wide range based on a pumping current flowing through the oxygen pumping cell under the execution of oxygen pumping action against the measurement chamber by controlling the energization state of the oxygen pumping cell such that an electromotive force developed between the electrodes of the oxygen concentration detection cell reaches a target value.

It is feasible in the above embodiment to divide the function of one component among a plurality of components or combine the functions of a plurality of components into one. Any of the technical features of the above embodiment may be omitted, replaced or combined as appropriate. All of embodiments and modifications derived from the technical scope of the following claims are included in the present invention.

The present invention can be embodied in various forms such as not only the above-described sensor control device 1, but also a system including the gas sensor device 1, a program for allowing a computer to function as the sensor control device 1, a non-transitory tangible storage media storing therein such a program, a sensor control method, and the like.

The entire contents of Japanese Patent Application No. 2017-196042 (filed on Oct. 6, 2017) are herein incorporated by reference. The scope of the invention is defined with reference to the following claims.

What is claimed is:

1. A sensor control device for controlling a gas sensor, the gas sensor comprising a sensor element and a heater that heats the sensor element and being adapted for detecting the concentration of a specific gas component contained in a gas under measurement, the sensor element having at least one cell that includes a solid electrolyte body and a pair of electrodes arranged on the solid electrolyte body so as to cause a flow of concentration detection current between the pair of electrodes in accordance with the concentration of the specific gas component, the sensor control device comprising:
a temperature detection portion configured to detect a temperature value of the solid electrolyte body; and
a control portion configured to perform feedback control on a heat generation amount of the heater based on a predetermined feedback condition so that a deviation between the detected temperature value and a predetermined target value becomes zero,
wherein the feedback condition is set such that, when an evaluation gas simulating a combustion exhaust gas discharged from an internal combustion engine by combustion of a stoichiometric air-fuel ratio mixture in the internal combustion engine is supplied as the gas under measurement to the gas sensor while maintaining a temperature of the evaluation gas at 25° C. and switching a gas flow rate of the evaluation gas between 10 m/s and 60 m/s every 10 seconds, a variation width of the concentration detection current is 1.6 μA or smaller.

2. The sensor control device according to claim 1,
wherein the feedback condition includes a feedback term.

3. The sensor control device according to claim 2
wherein the feedback condition includes at least a proportional term and an integral term as feedback terms.

4. A sensor unit, comprising:
a gas sensor comprising a sensor element that has at least one cell, which includes a solid electrolyte body and a pair of electrodes arranged on the solid electrolyte body, and a heater that heats the sensor element; and
the sensor control device according to claim 1.
